(19) United States
(12) Patent Application Publication
(10) Pub. No.: US 2012/0066643 A1
(43) Pub. Date: Mar. 15, 2012

(54) SYSTEM, METHOD AND APPARATUS FOR PRESENTING A USER INTERFACE

(75) Inventor: Matthew Blake McRae, Laguna Beach, CA (US)

(73) Assignee: VIZIO, INC., Irvine, CA (US)

(21) Appl. No.: 12/878,054

(22) Filed: Sep. 9, 2010

(51) Int. Cl. G06F 3/048

(52) U.S. Cl. 715/810; 715/764

(57) ABSTRACT

An application for a system for portraying a user interface of one device on another includes two devices, a primary device and a secondary device. Upon detection of the primary device, either within wireless range or direct connection, the devices communicate with each other, the secondary device portrays the user interface currently displayed on the primary device on a display of the secondary device. Thereafter, the primary device is controlled by user input devices interfaced to the secondary device that control the portrayed user interface

### FIELD OF THE INVENTION

This invention relates to the field of display devices and more particularly to a system for replicating a user interface of one device on the display device.

### BACKGROUND OF THE INVENTION

Many display devices such as televisions, computer system, Global Positioning Systems, portable televisions, etc, have very high quality displays. Many smaller devices such as cellular phones, calculators, media players, music players, small portable devices, etc, have high quality displays that are generally smaller in size. For many people, using such smaller displays is difficult due to the size of their display and due to their limited input capabilities, especially for entering text (e.g. keypads or touch screens).

When a device having a smaller or less capable display and less capable input device is used in the locale of another device having a more capable display and perhaps, a more capable input device; there is often recognition by each device that the other device is present. For example, one device detects the proximity of the other because they are connected by a cable or they are within wireless range, etc. This still does not help in viewing a user interface on the device having a smaller or less capable display.

In the past, a larger display such as a monitor or a television has been connected to a display output port of a device, typically a personal computer (e.g. VGA output port). This permitted the larger display to portray either an exact image of what is displayed on the device or, in some modes of operation, an extended desktop, effectively increasing the area of the original display of the device. Such a configuration allowed viewing of the output of the device on a, perhaps, a larger display, but this operation did not remote the user interface to the larger display monitor or television. Likewise, remote control of a device, typically a personal computer, was performed from a remote computer, often by a technical support person. This provides for remote control of a personal computer by a remote technician. While this technique does remote the user interface of a PC to another PC it does not provide the wider general solution of allowing a user to remote the user interface of a device other than a PC to another PC as for example, allowing the user to remote the user interface of his cell phone to the television and then to manipulate the user interface with the television remote control device nor does it allow the user to remote the user interface of other smaller form factor devices such as Apple iPads/itouches/iPhones/Android devices and other devices to larger form factor devices such as televisions and then to manipulate the user interface with the television remote rather than the touch sensitive display of the smaller form factor device.

What is needed is a portrayal of the user interface of a less capable display onto the display of the more capable device for improved visibility and interaction.

### SUMMARY

The present invention includes two devices, a primary device and a secondary device. Upon the primary device coming within wireless range of the secondary device or upon the primary device being connected to the secondary device, the devices communicate with each other and the secondary device portrays the user interface currently displayed on the primary device on a display of the secondary device. Thereafter, the primary device is controlled by user input devices interfaced to the secondary device that control the portrayed user interface.

In one embodiment, a system for portraying a user interface is disclosed. The system includes a primary device that has a display and a first interface and a secondary device that has a display and a second interface. The system has a way of detecting when the primary device is within wireless range of the secondary device (typical of devices such as Blue Tooth devices that once paired will automatically connect when in range of each other) or is connected to the secondary device through a connection such as a wired connection. Responsive to detecting the primary device, the primary device is communicatively coupled to the secondary device through the first and second interface and a user interface of the primary device is portrayed on the display of the secondary device.

In another embodiment, a method of portraying a user interface from a primary device on a secondary device is disclosed including detecting the primary device and, responsive to such, establishing a communications link between the primary device and the secondary device then communicating information regarding the user interface currently displayed on the primary device to the secondary device and portraying the user interface currently displayed on the primary device on a display of the secondary device.

In another embodiment, a system for portraying a user interface is disclosed including a primary device that has a display and a first interface and a secondary device that has a display, a processor and a second interface. Software running on the processor detects when the primary device is within communications range of the secondary device (or connected) and responsive to the primary device being within the pre-determined range of the secondary device, the software establishes a communications link with the secondary device through the first and second interface. Thereafter, the software receives user interface data from the primary device and portrays a copy of the user interface on the display of the secondary device.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a plan view of a primary device (e.g. television) with a jack accepting a secondary device.

FIG. 2 illustrates a plan view of a primary device (e.g. television) connected to a secondary device by a cable.

FIG. 3 illustrates a plan view of a primary device (e.g. television) connected to a secondary device by a wireless transmission.

FIG. 4 illustrates a schematic view of a typical monitor/television device.

FIG. 5 illustrates a first flow chart of the present invention.

FIG. 6 illustrates a first flow chart of the present invention.

FIG. 7 illustrates a second flow chart of the present invention.

FIG. 8 illustrates a third flow chart of the present invention.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures. Throughout this description, a cellular phone is used as an example of a primary device and a television is used as an example of a secondary device. Many other primary devices are anticipated, including but not limited to, cellular phones, cordless phones, music players, media players, electronic photo frames, global positioning systems, portable DVD players, etc. Many other secondary devices are anticipated, including but not limited to, portable televisions, media players, global positioning systems, computer systems, electronic photo frames, etc. It is also anticipated that many products fall into both the primary device and secondary device categories in different situations. For example, an electronic photo frame having a high-resolution 10.4″ display is at times a secondary device to a cellular phone having a 4″ display and, the electronic photo frame is at times a primary device to a high definition television.

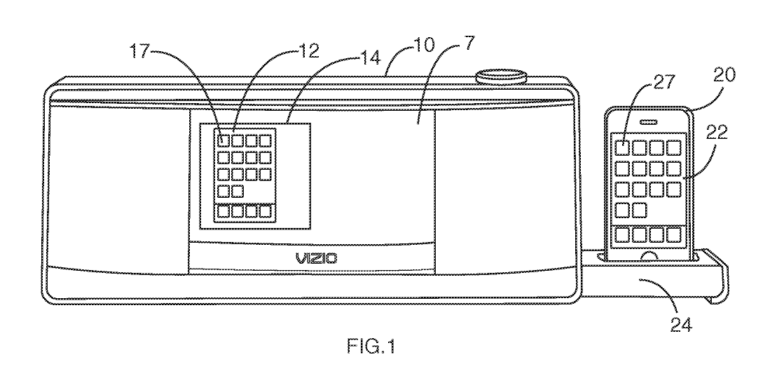

Referring to FIG. 1 a plan view of an exemplary secondary device 10 (e.g. television) with a device jack 24 for accepting a primary device 20 is described. In this exemplary embodiment, the primary device 20 is a cellular phone. As known in the industry, many such devices 20 have jacks, often located on a bottom surface of the device 20. These jacks are intended for connecting to, for example, charging systems, sound systems, vehicle audio systems, etc. In this embodiment, the primary device 20 is plugged into a device jack 24. In this, the secondary device 10 detects the primary device 20. The device jack 24 has communications paths connecting the primary device 20 with the secondary device 10 providing sufficient communication of information between the primary device 20 and the secondary device 10 to portray the user interface 22 of the primary device 20 on the display 7 of the secondary device 10. For example, the portrayed user interface 12 is shown within a menu or window 14 on the display 7 of the secondary device 10.

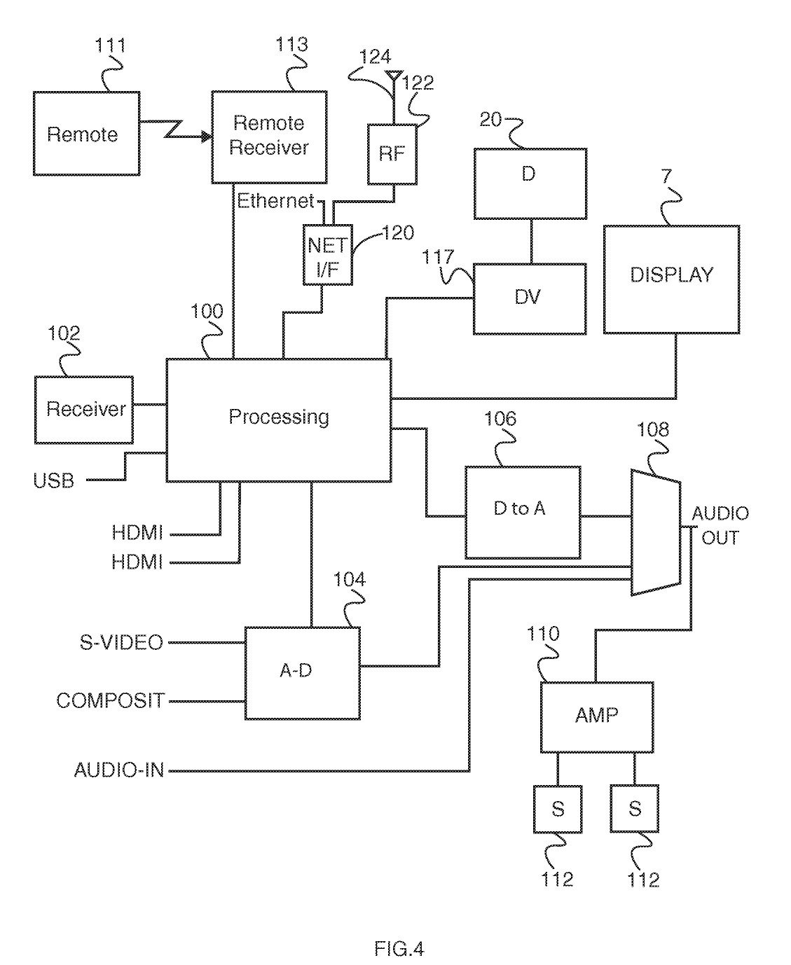

In some embodiments, the communication path includes a high-speed display communications signal such as a High Definition Multimedia Interface (HDMI) signal and the user interface display 22 is replicated as the portrayed user interface 12 in, for example, a picture-in-picture image. In other embodiments, a processor 100 (see FIG. 4) of the secondary device 10 generates the portrayed user interface 12 locally within the secondary device 10. For example, the portrayed user interface is displayed in a menu or pop-up 14 using data transferred from the primary device 20 through the device jack 24 to the secondary device 10. In this example, the primary device 20 communicates the icon and location of the icon for an applet to the secondary device 10 and the secondary device 10 displays the icon at an appropriate location. Since much of a typical user interface is relatively static, this embodiment requires less bandwidth and works well when there is little or no motion/animation.

Once connected, user interface directives are captured by the secondary device 10 and transferred to the primary device 20 through the interface (e.g. device jack 24). For example, if using a remote control 111 interfaced to the secondary device 10 (see FIG. 4), a user positions a cursor over the top left applet icon 17 and selects that icon 17, a message is sent from the secondary device 10 to the primary device 20 informing the primary device 20 that the applet associated with the icon 27 has been selected and the primary device 20 executes the applet.

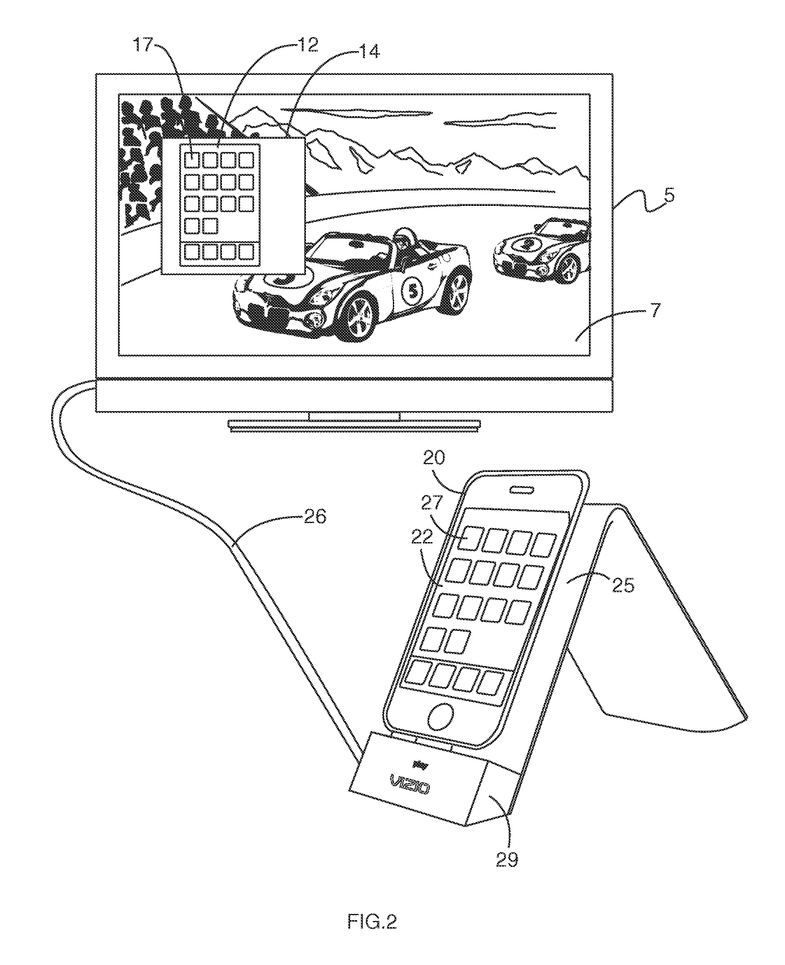

Referring to FIG. 2, a plan view of another secondary device 5 (e.g. television) connected to a primary device 20 by a cable 26 is described. In this exemplary embodiment, the primary device 20 is a cellular phone. As known in the industry, many such devices 20 have jacks, often located on a bottom surface of the device 20, for connecting to, for example, charging systems, sound systems, vehicle audio systems, etc. In this embodiment, the primary device 20 is plugged into a device jack 29 of a stand 25 having communications paths within a cable 26. Recognizing the primary device 20, the secondary device 5 connects with the primary device 20. The user interface 22 of the primary device 20 is portrayed on the display 7 of the secondary device 5. For example, the portrayed user interface 12 is presented within a menu or window 14 on the display 7 of the secondary device 5.

In some embodiments, the communication path includes a high-speed display communications signal such as a High Definition Multimedia Interface (HDMI) signal and the user interface display 22 is replicated as the portrayed user interface 12 in, for example, a picture-in-picture image or menu 14. In other embodiments, a processor 100 (see FIG. 4) of the secondary device 5 generates the portrayed user interface 12. The portrayed user interface is typically displayed in, for example, a menu or pop-up 14 using data transferred from the primary device 20 through the device jack 29 and cable 26 to the secondary device 5. For example, the primary device 20 communicates the icon and location of the icon 27 for an applet to the secondary device 5 and the secondary device 5 displays the icon 17 at an appropriate location. This embodiment requires less bandwidth and works well when there is little or no motion/animation.

Once connected, user interface directives are captured by the secondary device 5 and transferred to the primary device 20 through the interface (e.g. device jack 29 and cable 26). For example, if using a remote control 111 interfaced to the secondary device 5 (see FIG. 4), a user positions a cursor over the top left applet icon 17 and selects that icon 17, a message is sent from the secondary device 15 to the primary device 20 informing the primary device 20 that the applet associated with the icon 27 has been selected and the primary device 20 executes the applet.

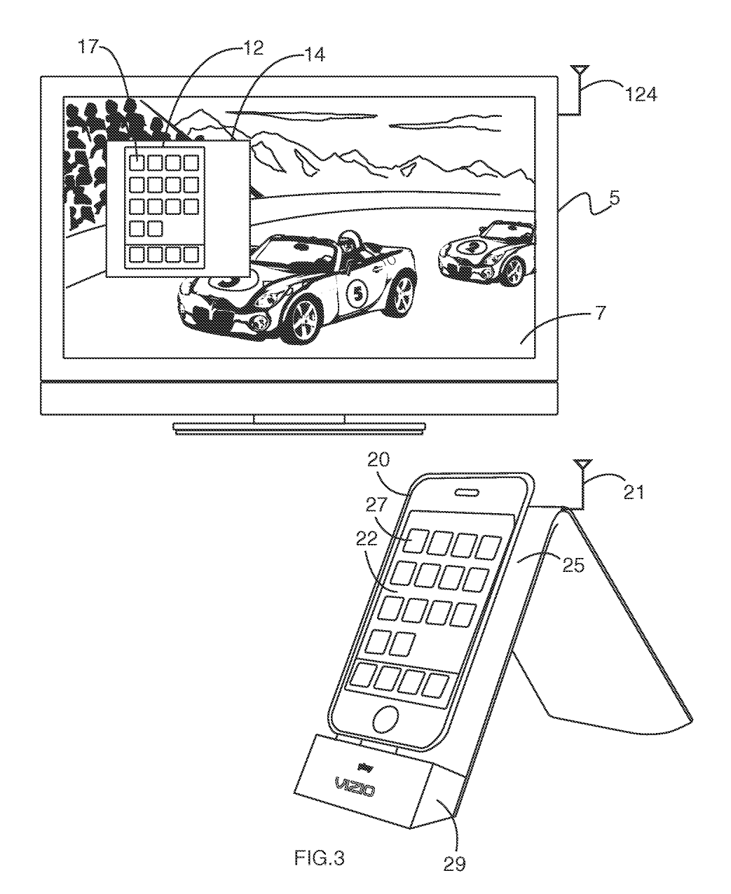

Referring to FIG. 3, a plan view of the secondary device 5 (e.g. television) connected to a primary device 20 by a wireless connection is described. In this exemplary embodiment, the primary device 20 is a cellular phone. As known in the industry, many such devices 20 have jacks, often located on a bottom surface of the device 20, for connecting to, for example, charging systems, sound systems, vehicle audio systems, etc. In this embodiment, the primary device 20 is plugged into a device jack 29 of an stand 25 having a wireless communications paths through an antenna 21 connecting the primary device 20 with the secondary device 5 such that the user interface 22 of the primary device 20 is portrayed on the display 7 of the secondary device 5. For example, the portrayed user interface 12 is presented within a menu or window 14 on the display 7 of the secondary device 5.

In some embodiments, the wireless communication path may be some standard protocol such as Wifi (802.11) or Bluetooth. Proprietary protocols may be used or other protocols known in the art may also be used and are therefore anticipated.

In some embodiments, the wireless communication path may be supported by a docking station into which the primary device is docked and in which the primary device communicates with the docking station via a wired connection and the docking station communicates with the secondary device via the wireless connection.

In some embodiments, the wireless communication path includes a high-speed display communications signal such as a High Definition Multimedia Interface (HDMI) signal and the user interface display 22 is replicated as the portrayed user interface 12 in, for example, a picture-in-picture image 14. In other embodiments, a processor 100 (see FIG. 4) of the secondary device 5 generates the portrayed user interface 12 in, for example, a menu or pop-up 14. The portrayed user interface 12 is created using data transferred wirelessly to/from the primary device's antenna 21 through the antenna 124 of the secondary device 5. For example, the primary device 20 communicates the icon and location of the icon 27 for an applet to the secondary device 5 and the secondary device 5 displays the icon 17 at an appropriate location. This embodiment requires less bandwidth and works well when there is little or no motion/animation.

In some embodiments, the wireless communications path is directly from the primary device 20 to the secondary device 5, for example, the primary device 20 and secondary device 5 have

Bluetooth transceivers. In this, when the primary device 20 is within range of the secondary device 5, the communications link is established and the user interface 12 is portrayed on the display of the secondary device 5.

Once connected, user interface directives are captured by the secondary device 5 and transferred to the primary device 20 through the wireless interface (e.g. antennas 21/124). For example, the user operates a remote control 111 interfaced to the secondary device 5 (see FIG. 4) and positions a cursor over the top left applet icon 17 and selects that icon 17. A message (e.g. data packet) is sent from the secondary device 5 to the primary device 20 informing the primary device 20 that the applet associated with the icon 27 has been selected and the primary device 20 executes the applet.

Referring to FIG. 4, a schematic view of a typical device (television) 5 of the present invention will be described. This figure is intended as a representative schematic of a typical secondary device 5/10, in this example, a monitor/television 5/10. In practice, some elements are not present in some monitors/televisions 5/10 and/or additional elements are present in some monitors/televisions 5. In this example, a display panel 7 is connected to a processing element 100. The display panel 7 is representative of any known display panel including, but not limited to, LCD display panels, Plasma display panels, OLED display panels, LED display panels and cathode ray tubes (CRTs).

The processing element 100 accepts video inputs and audio inputs selectively from a variety of sources including an internal television broadcast receiver 102, High-definition Multimedia Interface (HDMI), USB ports and an analog-to-digital converter 104. The analog-to-digital converter 104 accepts analog inputs from legacy video sources such as S-Video and Composite video and converts the analog video signal into a digital video signal before passing it to the processing element. The processing element controls the display of the video on the display panel 7.

Audio emanates from either the broadcast receiver 102, the legacy source (e.g., S-Video) or a discrete analog audio input (Audio-IN). If the audio source is digital, the processing element 100 routes the audio to a digital-to-analog converter 106 and then to an input of a multiplexer 108. The multiplexer 108, under control of the processing element 100, selects one of the audio sources and routes the selected audio to the audio output and an internal audio amplifier 110. The internal audio amplifier 110 amplifies the audio and delivers it to internal speakers 112.

The processing element 100 accepts commands from a remote control 111 through remote receiver 113. Although IR is often used to communicate commands from the remote control 111 to the remote receiver 113, any known wireless technology is anticipated for connecting the remote control 111 to the processing element 100 including, but not limited to, radio frequencies (e.g., Bluetooth), sound (e.g., ultrasonic) and other spectrums of light. Furthermore, it is anticipated that the wireless technology be either one way from the remote 111 to the receiver 113 or bi-directional.

In some embodiments, the television/monitor 5/10 is connected to a network, such as the Internet or local area network. In these embodiments, a network interface 120 attaches to the network and transfers data back and fourth between the processing element 100 and the network. In some embodiments, the network is a wired network such as an Ethernet network. In other embodiments, the network is wireless such as WiFi/802.11 and a wireless interface 122 with antenna 124 is provided.

In some embodiments, the processing element connects to the primary device 20 through the wireless interface 122. In this, all signaling required to mimic or duplicate the user interface 22 of the primary device 20 is performed over a wireless link to/from the primary device 20 through the wireless interface to/from the processing element 100.

In some embodiments, the processing element connects to the primary device 20 through a wired interface 117. In this, all signaling required to mimic, display or duplicate the user interface 22 of the primary device 20 is performed over the wired link 26 to/from the primary device 20 through the wired link 26 to/from the processing element 100.

In some embodiments, the presence of the primary device 20 is automatically detected and the window 14 containing the portrayed user interface 14 is automatically displayed on the secondary device's display 7 after the primary device 20 is connected to, for example, the interface 24/29 or is within wireless range of the secondary device's antenna 124.

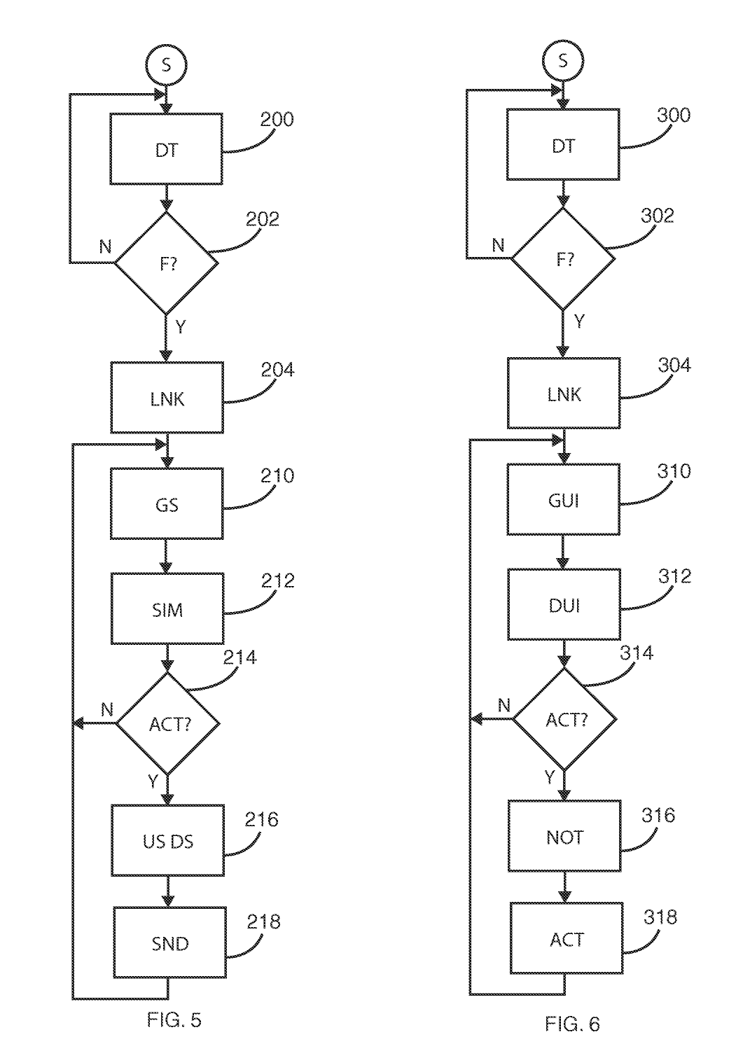

Referring to FIG. 5, a first flow chart of the present invention is described. This is an exemplary program flow executed within the processing element 100. In embodiments having automatic detection, detection is made 200 until the primary device is found 202. Once found 202, a link (e.g. connection) is made between the primary device 20 and the secondary device, e.g. television 5/10. Until the link is broken, the secondary device 5/10 retrieves 210 state information from the primary device 20 and simulates 212 the user interface on the secondary device's display 7. For example, if an icon for an email applet is displayed on the user interface 22 of the primary device 20, an indication of such is transferred 210 to the secondary device 5/10 and the secondary device 5/10, using local knowledge of the applet, displays the icon for the email applet on the secondary device user interface 12. In this, the amount of data and, hence, bandwidth of the interface between the primary device 20 and the secondary device 5/10 is minimized.

A test is made to determine if an activity is required 214. If no activity, 214, the status is checked 210 and, if any changes, the changes are simulated 212 on the secondary device's user interface 12. For example, no activity has occurred, but the primary device 20 is a cellular phone and it just received an incoming call and, therefore, the changes (e.g. notice of incoming call) are simulated 212 on the secondary device's user interface 12.

If an activity is required 214, such as the email icon is selected using, for example, the remote control 111, the secondary device's user interface 12 is updated 216 to provide quick feedback to the user (e.g., the email icon is highlighted) and the command/activity is sent 218 to the primary device 20. Following with this example, the primary device 20 receives the command/activity (e.g. select the email applet), and starts the email applet. When the secondary device 5/10 again gets the status 210, the status reflects that the email applet is running and when the secondary device 5/10 simulates the user interface 212, the user interface now reflects that the email applet is running (e.g. displays list of messages in the inbox).

Referring to FIG. 6, a second flow chart of the present invention is described. This is an exemplary program flow executed within the processing element 100. In embodiments having automatic detection, detection is made 300 until the primary device is found 302. Once found 302, a link 304 (e.g. connection) is made between the primary device 20 and the secondary device, e.g. television 5/10. Until the link is broken, the secondary device 5/10 retrieves 310 the user interface from the primary device 20 and displays 312 the user interface on the secondary device's display 7. For example, the entire set of pixels currently displayed on the primary device's user interface 22 are transferred 310 to the secondary device 5/10 and the secondary device 5/10 displays the pixels on the secondary device user interface 12.

A test is made to determine if an activity is required 314. If no activity, 314, the primary device user interface is again retrieved 310 and displayed 312 on the secondary device's user interface 12. For example, no activity has occurred, but the primary device 20 is a cellular phone and it just received an incoming call and the changes notice of incoming call is now displayed on the primary device's user interface 22 and transferred 310 and displayed 312 on the secondary device's user interface 12.

If an activity is required 314, such as the email icon is selected on the secondary device's user interface 12 using, for example, the remote control 111, the secondary device 10 is notified 316 and the command/activity acted upon 318 by the secondary device 10. Following with a similar example, the secondary device 5/10 receives the command/activity 314 (e.g. select the email applet), sends notice 316 (e.g. the coordinates of the email icon and an invoke function) to the primary device 20, the primary device 20 acts on the notice 318 by initiating the email applet, thereby displaying, for example, messages in the inbox. When the secondary device 5/10 again gets the user interface 310 from the primary device 20, the user interface now reflects that the email applet is running.

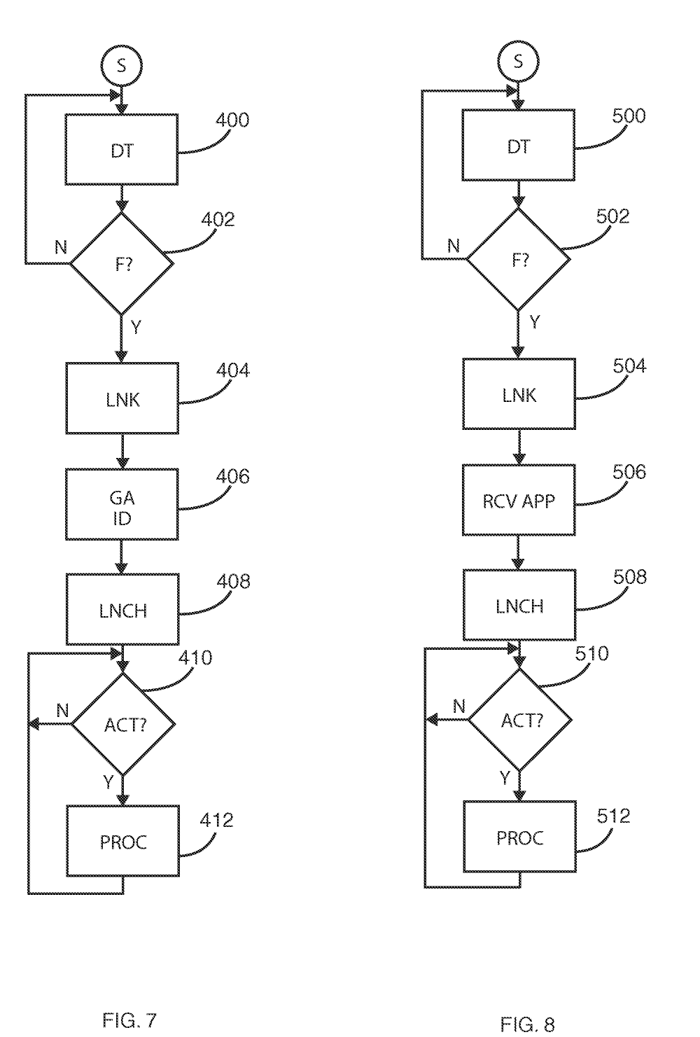

Referring to FIG. 7 a third flow chart of the present invention is described. This is an exemplary program flow executed within the processing element 100. In embodiments having automatic detection, detection is made 400 until the primary device is found 402. Once found 402, a link 404 (e.g. connection) is made between the primary device 20 and the secondary device, e.g. television 5/10. Until the link is broken, the secondary device 5/10 retrieves 406 Get Application ID of a software application and launches the identified application 408. For example, if the primary device is a cell phone or a PDA and the user selects an application icon 27, once the link is made the ID of the ICON 27 is sent to the secondary device 5/10 which launches the software application mimicking the application normally executed on the primary device when ICON 27 is selected. Once an activity request 410 is received, it is processed 412 including the prompting and receiving data input from the user and transference of any data back to the primary device 20 and control is passed back to waiting for activity request 410. In an alternate embodiment, data requested by the software application may result in data being obtained over a network attached to the secondary device. This action may be less costly in terms of monetary charges associated with accessing internet data over a cell phone as opposed to accessing the same data over a network accessible by the secondary device.

Referring to FIG. 8 a forth flow chart of the present invention is described. This is an exemplary program flow executed within the processing element 100. In embodiments having automatic detection, detection is made 500 until the primary device is found 502. Once found 502, a link 504 (e.g. connection) is made between the primary device 20 and the secondary device, e.g. television 5/10. Until the link is broken, the secondary device 5/10 receives software application 506 from primary device 20 and launches the application 508. For example, if the primary device is a cell phone or a PDA and the user selects an application icon 27, once the link is made a software application associated with an ICON 27 is sent to the secondary device 5/10 which launches the received software application that mimics the application normally executed on the primary device when ICON 27 is selected. Once an activity request 510 is received, it is processed 512 including the prompting and receiving data input from the user and transference of any data back to the primary device 20 and control is passed back to waiting for activity request 510. In an alternate embodiment, data requested by the software application may result in data being obtained over a network attached to the secondary device. This action may be less costly in terms of monetary charges associated with accessing internet data over a cell phone as opposed to accessing the same data over a network accessible by the secondary device.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for portraying a user interface, the system comprising:
a primary device, the primary device having a display and a first interface;
a secondary device, the secondary device having a display and a second interface;
means for detecting when the first interface is connected to the second interface;
responsive to detecting that the primary device is connected to the secondary device, a means for communicatively coupling the primary device to the secondary device through the first and second interface; and
means for portraying a user interface of the primary device on the display of the secondary device.

2. The system for portraying a user interface of claim 1, wherein the primary device is a hand held mobile device and the secondary device is a television.

3. The system for portraying a user interface of claim 1, wherein the first interface and the second interface is a wireless interface.

4. The system for portraying a user interface of claim 1, wherein the first interface and the second interface is a wired interface.

5. The system for portraying a user interface of claim 1, further comprising a means for controlling the primary device from an input device of the secondary device.

6. The system for portraying a user interface of claim 1, wherein the means for portraying a user interface of the primary device on the display of the secondary device portrays the user interface within a menu.

7. The system for portraying a user interface of claim 1, wherein the means for portraying a user interface of the primary device on the display of the secondary device portrays the user interface occupying the entire display of the secondary device.

8. The system of claim 1 where the means for portraying the user interface of the primary device is through a software application program executing on the secondary device.

9. The system of claim 1 where the means for communicatively coupling the primary device to the secondary device is through software applications executing on the primary device and the secondary device.

10. A method of portraying a user interface from a primary device on a secondary device, the method comprising:
detecting the secondary device;
establishing a communications link between the primary device and the secondary device;
communicating information regarding the user interface currently displayed on the primary device to the secondary device; and
portraying the user interface currently displayed on the primary device on a display of the secondary device.

11. The method of claim 10, wherein the information comprises pixel information of a display of the primary device.

12. The method of claim 10, wherein the information comprises state information regarding the user interface currently displayed on the primary device and the secondary device uses the state information in portraying the user interface currently displayed on the primary device on the display of the secondary device.

13. The method of claim 10 wherein the information comprises the identification of a software application resident on the secondary device which will be executed to emulate the user interface of the primary device.

14. The method of claim 10 wherein the information comprises a software application which will be launched when received by the secondary device which will emulate the user interface of the primary device.

15. The method of claim 10, further comprising a step of:
receiving a directive from an input device, the input device communicating with the secondary device;
sending an indication of the directive from the secondary device to the primary device over the communication link; and
operating on the directive at the primary device.

16. The method of claim 15, wherein the step of operating includes updating the user interface currently displayed on the primary device and the step of portraying the user interface currently displayed on the primary device on the display of the secondary device is repeated, thereby updating the display on the secondary device.

17. The method of claim 15, whereby the step of communicating information is performed using a wireless link.

18. The method of claim 15, whereby the step of communicating information is performed using a wired link.

19. A system for portraying a user interface, the system comprising:
a primary device, the primary device having a display and a first interface;
a secondary device, the secondary device having a display, a processor and a second interface;
software running on the processor that detects a presence of the primary device;
responsive to the presence of the primary device, the software establishes a communications link with the secondary device through the first and second interface; and
the software receives user interface data from the primary device and the software portrays a copy of the user interface on the display of the secondary device.

20. The system for portraying a user interface of claim 19, wherein the primary device is a hand held mobile device and the secondary device is a television.

21. The system for portraying a user interface of claim 19, wherein the first interface and the second interface is a wireless interface.

22. The system for portraying a user interface of claim 19, wherein the first interface and the second interface is a wired interface.

23. The system for portraying a user interface of claim 19, the software receiving a directive from a user interface device and the software sending an indication of the directive to the primary device over the communications link, the user interface device associated with the secondary device.

24. The system for portraying a user interface of claim 19, wherein the software portrays the copy of the user interface within a menu.

25. The system for portraying a user interface of claim 19, wherein the software portrays the copy of the user interface over the entire display of the secondary device.

26. The system for portraying a user interface of claim 19, wherein the user interface data includes a copy of the user interface.

27. The system for portraying a user interface of claim 19, wherein the user interface data includes indications related to the user interface and the software uses the indications to portray the copy of the user interface on the display of the secondary device.
